(19) United States
(12) Patent Application Publication
(10) Pub. No.: US 2025/0379684 A1
(43) Pub. Date: Dec. 11, 2025

(54) METHOD FOR DETERMINING HARQ PROCESS ID, TERMINAL, AND NETWORK SIDE DEVICE

(71) Applicant: VIVO MOBILE COMMUNICATION CO., LTD., Dongguan (CN)

(72) Inventors: Na LI, Dongguan (CN); Chaojun ZENG, Dongguan (CN); Xueming PAN, Dongguan (CN)

(21) Appl. No.: 19/312,344

(22) Filed: Aug. 28, 2025

Related U.S. Application Data
(63) Continuation of application No. PCT/CN2024/078147, filed on Feb. 22, 2024.

(30) Foreign Application Priority Data
Feb. 28, 2023 (CN) 202310187811.6

(51) Int. Cl. H04L 1/1812; H04W 72/04

(52) U.S. Cl. CPC H04L 1/1812; H04W 72/04

(57) ABSTRACT

Embodiments of this application disclose a method for determining a HARQ process ID, a terminal, and a network side device, pertaining to the field of communication technologies. The method for determining a HARQ process ID in embodiments of this application includes: A terminal determines a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers; or the terminal determines, based on numbers of transmission occasions, a third HARQ process ID associated with each M transmission occasions within one period of the configured grant PUSCH.

### CROSS-REFERENCE TO RELATED APPLICATIONS

This application is a continuation of International Patent Application No. PCT/CN2024/078147, filed on Feb. 22, 2024, which claims priority to Chinese Patent Application No. 202310187811.6 filed in China on Feb. 28, 2023, both of which are incorporated herein by reference in their entireties.

### TECHNICAL FIELD

This application pertains to the field of communication technologies, and specifically relates to a method for determining a hybrid automatic repeat request (Hybrid Automatic Repeat Request, HARQ) process identifier (ID), a terminal, and a network side device.

### BACKGROUND

In the related art, within one period of a configured grant (Configured Grant, CG) physical uplink shared channel (Physical Uplink Shared Channel, PUSCH), only one transmission occasion is supported, or transmission of a same transport block (Transport Block, TB) on a plurality of transmission occasions is supported. Therefore, only one HARQ process ID needs to be determined within one period of the configured grant PUSCH.

To resolve issues such as a large service packet, a variable packet size, and time-of-arrival jitter of a data packet in services such as XR, in the related art, a transmission mechanism is proposed, where a plurality of transmission occasions are supported within one period of the configured grant PUSCH, and different transmission occasions may be used to transmit different TBs.

### SUMMARY

According to a first aspect, a method for determining a HARQ process ID is provided, including: A terminal determines a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers; or the terminal determines, based on numbers of transmission occasions, a third HARQ process ID associated with each M transmission occasions within one period of the configured grant PUSCH.

According to a second aspect, a method for determining a HARQ process ID is provided, including: A network side device determines a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions; and N and M are positive integers; or the network side device determines, based on numbers of transmission occasions, a third HARQ process ID associated with each M transmission occasions within one period of the configured grant PUSCH.

According to a third aspect, an apparatus for determining a HARQ process ID is provided, including: a determining module, configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions; and N and M are positive integers; or a determining module, configured to determine, based on numbers of transmission occasions, a third HARQ process ID associated with each M transmission occasions within one period of the configured grant PUSCH.

According to a fourth aspect, an apparatus for determining a HARQ process ID is provided, including: a determining module, configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions; and N and M are positive integers; or a determining module, configured to determine, based on numbers of transmission occasions, a third HARQ process ID associated with each M transmission occasions within one period of the configured grant PUSCH.

According to a fifth aspect, a terminal is provided. The terminal includes a processor and a memory, the memory stores a program or instructions executable on the processor, and when the program or instructions are executed by the processor, steps of the method in the first aspect are implemented.

According to a sixth aspect, a terminal is provided, including a processor and a communication interface. The processor is configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers. Alternatively, the processor is configured to determine, based on numbers of transmission occasions, a third HARQ process ID associated with each M transmission occasions within one period of the configured grant PUSCH.

According to a seventh aspect, a network side device is provided. The network side device includes a processor and a memory, the memory stores a program or instructions executable on the processor, and when the program or instructions are executed by the processor, steps of the method in the second aspect are implemented.

According to an eighth aspect, a network side device is provided, including a processor and a communication interface. The processor is configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers. Alternatively, the processor is configured to determine, based on numbers of transmission occasions, a third HARQ process ID associated with each M transmission occasions within one period of the configured grant PUSCH.

According to a ninth aspect, a readable storage medium is provided. The readable storage medium stores a program or instructions. When the program or the instructions are executed by a processor, steps of the method in the first aspect are implemented, or steps of the method in the second aspect are implemented.

According to a tenth aspect, a communication system is provided, including a terminal and a network side device. The terminal may be configured to perform steps of the method in the first aspect, and the network side device may be configured to perform steps of the method in the second aspect.

According to an eleventh aspect, a chip is provided. The chip includes a processor and a communication interface, the communication interface is coupled to the processor, and the processor is configured to run a program or instructions, to implement steps of the method in the first aspect or steps of the method in the second aspect.

According to a twelfth aspect, a computer program/program product is provided. The computer program/program product is stored in a storage medium, and the computer program/program product is executed by at least one processor to implement steps of the method in the first aspect or steps of the method in the second aspect.

### BRIEF DESCRIPTION OF THE DRAWINGS

FIG. 1 is a diagram of a wireless communication system according to an embodiment of this application;

FIG. 2 is a schematic flowchart of a method for determining a HARQ process ID according to an embodiment of this application;

FIG. 3 is a diagram of application of a method for determining a HARQ process ID according to an embodiment of this application;

FIG. 4 is a schematic flowchart of a method for determining a HARQ process ID according to an embodiment of this application;

FIG. 5 is a diagram of a structure of an apparatus for determining a HARQ process ID according to an embodiment of this application;

FIG. 6 is a diagram of a structure of an apparatus for determining a HARQ process ID according to an embodiment of this application;

FIG. 7 is a diagram of a structure of a communication device according to an embodiment of this application;

FIG. 8 is a diagram of a structure of a terminal according to an embodiment of this application; and

FIG. 9 is a diagram of a structure of a network side device according to an embodiment of this application.

### DETAILED DESCRIPTION

Technical solutions in embodiments of this application are clearly described below with reference to accompanying drawings in embodiments of this application. Clearly, the described embodiments are merely a part of rather than all embodiments of this application. All other embodiments obtained by a person of ordinary skill in the art based on embodiments of this application fall within the protection scope of this application.

In this application, the terms such as “first” and “second” are used to distinguish similar objects, but are not used to describe a specific sequence or order. It should be understood that, terms used in such a manner are interchangeable in a proper circumstance, so that embodiments of this application can be implemented in other orders than those illustrated or described herein. Moreover, the objects distinguished by “first” and “second” are usually of a same type, and the numbers of the objects are not limited. For example, there may be one or more first objects. In addition, “or” in this application indicates at least one of connected objects. For example, “A or B” covers three solutions: Solution 1: including A and not including B. Solution 2: including B and not including A. Solution 3: including both A and B. The character “/” in this specification generally indicates an “or” relationship between associated objects.

The term “indication” in this application may be a direct indication (or an explicit indication), or may be an indirect indication (or an implicit indication). The direct indication may be understood as that a sender explicitly notifies, in a sent indication, a receiver of content such as specific information, an operation that needs to be performed, or a request result. The indirect indication may be understood as that the receiver determines corresponding information based on an indication sent by the sender, or performs determining based on the indication sent by the sender and determines, based on a determining result, an operation that needs to be performed, a request result, or the like.

It should be noted that, technologies described in embodiments of this application are not limited to a long term evolution (Long Term Evolution, LTE)/LTE-advanced (LTE-Advanced, LTE-A) system, and may also be applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-Carrier Frequency Division Multiple Access, SC-FDMA), or other systems. The terms “system” and “network” in embodiments of this application are often used interchangeably, and the technologies described may be applied to the foregoing systems and radio technologies as well as other systems and radio technologies. A new radio (New Radio, NR) system is described below as an example, and NR terminology is used in most of the following descriptions. Nevertheless, these technologies may also be applied to a system other than the NR system, for example, a 6th generation (6th Generation, 6G) communication system.

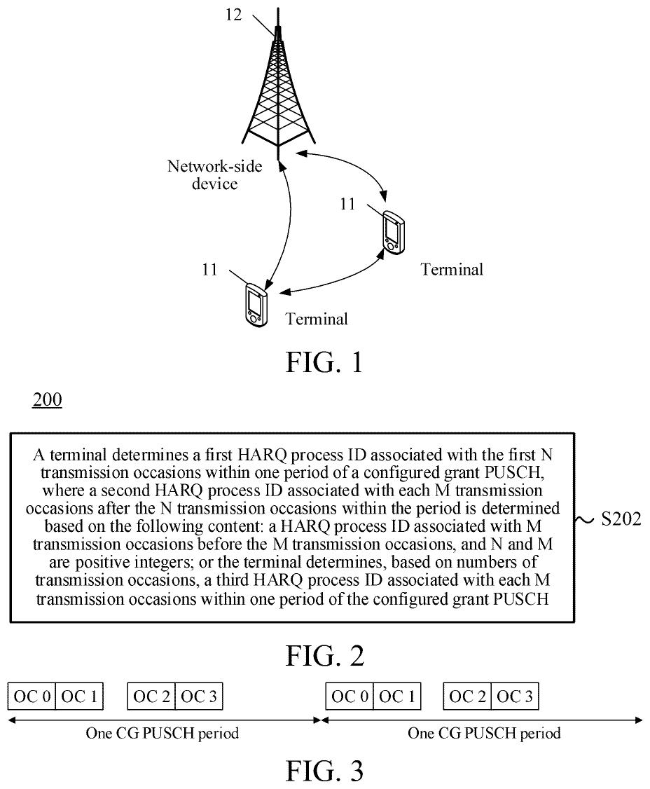

FIG. 1 is a block diagram of a wireless communication system to which an embodiment of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-Mobile Personal Computer, UMPC), a mobile internet device (Mobile Internet Device, MID), an augmented reality (Augmented Reality, AR)/virtual reality (Virtual Reality, VR) device, a robot, a wearable device (Wearable Device), a flight vehicle (flight vehicle), an in-vehicle device (Vehicle User Equipment, VUE), a ship-borne device, pedestrian user equipment (Pedestrian User Equipment, PUE), a smart home appliance (a home device with a wireless communication capability, such as a refrigerator, a television, a washing machine, or furniture), a game console, a personal computer (Personal Computer, PC), a teller machine, or a self-service machine. The wearable device includes a smart watch, a smart band, a smart headphone, smart glasses, smart jewelry (a smart bracelet, a smart wrist chain, a smart ring, a smart necklace, a smart anklet, or a smart ankle chain), a smart wrist band, smart clothing, or the like. The in-vehicle device may also be referred to as an in-vehicle terminal, an in-vehicle controller, an in-vehicle module, an in-vehicle component, an in-vehicle chip, an in-vehicle unit, or the like. It should be noted that, a specific type of the terminal 11 is not limited in this embodiment of this application. The network side device 12 may include an access network device or a core network device. The access network device may also be referred to as a radio access network (Radio Access Network, RAN) device, a wireless access network function, or a wireless access network unit. The access network device may include a base station, a wireless local area network (Wireless Local Area Network, WLAN) access point (Access Point, AP), a wireless fidelity (Wireless Fidelity, Wi-Fi) node, or the like. The base station may be referred to as a NodeB (NB), an evolved NodeB (Evolved Node B, eNB), a next generation NodeB (next generation NodeB, gNB), a new radio NodeB (New Radio Node B, NR NodeB), an access point, a relay station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or some other proper terminology in the art. The base station is not limited to a specific technical vocabulary provided that the same technical effects are achieved. It should be noted that, in this embodiment of this application, only the base station in the NR system is used as an example for description, while a specific type of the base station is not limited.

Because different TBs need to correspond to different HARQ process IDs, different HARQ process IDs need to be determined for a plurality of transmission occasions within one period of the configured grant PUSCH. Embodiments of this application provide a method for determining a HARQ process ID, a terminal, and a network side device, to resolve a problem of failure to determine HARQ process IDs associated with a plurality of transmission occasions within one period of a configured grant PUSCH.

In embodiments of this application, the terminal may determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions. Alternatively, the terminal may determine, based on numbers of transmission occasions, a third HARQ process ID associated with each M transmission occasions within one period of the configured grant PUSCH. In embodiments of this application, HARQ process IDs associated with a plurality of transmission occasions within one period of the configured grant PUSCH can be determined, which helps improve effectiveness of the communication system.

A method for determining a HARQ process ID according to embodiments of this application is described below with reference to accompanying drawings by using some embodiments and application scenarios thereof.

As shown in FIG. 2, an embodiment of this application provides a method 200 for determining a HARQ process ID. The method may be performed by a terminal. In other words, the method may be performed by software or hardware installed in the terminal. The method includes the following step:

S202. The terminal determines a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers; or the terminal determines, based on numbers of transmission occasions, a third HARQ process ID associated with each M transmission occasions within one period of the configured grant PUSCH.

In this embodiment, at least two transmission occasions may be configured within one period of the configured grant PUSCH; or transmission occasions for transmission of more than one transport block (Transport Block, TB) may be configured within one period of the configured grant PUSCH.

Optionally, N may meet at least one of the following:
(1) N=1.
(2) N=M. For example, both N and M are equal to 1, or both N and M are equal to the number of repetitions of the configured grant PUSCH.
(3) N is a predefined or higher-layer configured value. In embodiments of this application, the predefined value includes a value predefined directly, or a value determined according to a predefined rule. For example, N is determined based on at least one of the following: the period corresponding to the configured grant PUSCH; and the number of transmission occasions within one period of the configured grant PUSCH.

Optionally, in embodiments of this application, M=1, or M is the number of repetitions of the configured grant PUSCH.

In an example, N=1, and M=1. The terminal may determine, based on implementation, that a first HARQ process ID associated with the 1st transmission occasion within one period of the configured grant PUSCH is 1, and HARQ process IDs associated with subsequent transmission occasions within the period are determined by sequentially increasing by K (K=3). In this way, a HARQ process ID associated with the 2nd transmission occasion is 4, a HARQ process ID associated with the 3rd transmission occasion is 7, and so on.

In an example, N=2, and M=2. The terminal may determine, based on implementation, that a first HARQ process ID associated with the first two transmission occasions within one period of the configured grant PUSCH is 1, and a HARQ process ID associated with each two of subsequent transmission occasions within the period is determined by sequentially increasing by K (K=4). In this way, a HARQ process ID associated with the 3^{rd} transmission occasion and the 4^{th} transmission occasion is 5, a HARQ process ID associated with the 5^{th} transmission occasion and the 6^{th} transmission occasion is 9, and so on.

It should be noted that, when the terminal determines a HARQ process ID associated with the first N transmission occasions within one period based on implementation, the first N transmission occasions may be transmission occasions of a PUSCH actually sent by the terminal side within one period, whose positions depend on a transmission occasion from which the terminal starts transmission, and are not necessarily the first N transmission occasions configured for the terminal within one period.

In an example, the terminal may determine, based on numbers of transmission occasions, a third HARQ process ID associated with each M transmission occasions within one period of the configured grant PUSCH. In this example, M=1, or M is greater than 1, and M is a positive integer. In this example, the numbers of the transmission occasions may be numbers within one period. For example, within one period of the configured grant PUSCH, a number of the 1^{st} transmission occasion is 0, and numbers of subsequent transmission occasions are determined by sequentially increasing by 1. In this example, the numbers of the transmission occasions may alternatively be numbers within a plurality of periods. For example, numbers of four transmission occasions within the 1^{st} period are respectively 0, 1, 2, and 3; numbers of four transmission occasions in the 2^{nd} period are respectively 4, 5, 6, and 7; and so on. In this example, the numbers of the transmission occasions may alternatively be numbers within a plurality of periods. For example, the plurality of periods may be a plurality of periods within one system frame, or a plurality of transmission periods within a predefined time window.

In the method for determining a HARQ process ID according to this embodiment of this application, the terminal may determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions. Alternatively, the terminal may determine, based on numbers of transmission occasions, a third HARQ process ID associated with each M transmission occasions within one period of the configured grant PUSCH. In this embodiment of this application, HARQ process IDs associated with a plurality of transmission occasions within one period of the configured grant PUSCH can be determined, which helps improve effectiveness of a communication system.

In the method 200, the terminal may determine, based on implementation, the first HARQ process ID associated with the first N transmission occasions within one period of the configured grant PUSCH. The following describes two methods for calculating, by the terminal, the first HARQ process ID based on a formula.

In an example, when neither a first offset (for example, harq-ProcID-Offset2) nor a retransmission timer (for example, cg-RetransmissionTimer) is configured for the configured grant PUSCH, the first HARQ process ID is determined based on the following formula:

$$First HARQ process ID = [ floor ( CURRENT\_symbol / periodicity ) ] modulo nrofHARQ - Processes ;$$

where floor is a round-down operation; modulo is a modulo operation; CURRENT_symbol is the 1^{st} symbol of each transmission occasion or the 1^{st} transmission occasion in the first N transmission occasions or the 1^{st} transmission occasion of each M transmission occasions; periodicity is a length of the period of the configured grant PUSCH; and nrofHARQ-Processes is the number of available HARQ processes of the configured grant PUSCH.

In this example, if N corresponds to the number of repetitions of the configured grant PUSCH, for transmission occasions for repetition, the formula does not need to be applied to all the transmission occasions, but only needs to be applied to the 1^{st} transmission occasion in the plurality of transmission occasions for repetition. A plurality of transmission occasions for repetition of a same TB may correspond to a same HARQ process ID.

In an example, when a first offset (for example, HARQ-ProcID-Offset2) is configured for the configured grant PUSCH, the first HARQ process ID is determined based on the following formula:

$$First HARQ process ID = [ floor ( CURRENT\_symbol / periodicity ) ] modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion in the first N transmission occasions or the 1^{st} transmission occasion of each M transmission occasions; periodicity is a length of the period of the configured grant PUSCH; nrofHARQ-Processes is the number of available HARQ processes of the configured grant PUSCH; and harq-ProcID-Offset2 is the first offset.

In the foregoing two examples, the first N transmission occasions may be the first N transmission occasions configured within one period of the configured grant PUSCH, and the terminal may actually not transmit the PUSCH on the transmission occasions (it should be noted that when the UE does not need to transmit the PUSCH on a transmission occasion, the UE does not need to perform the foregoing formula to determine a HARQ process ID corresponding to the transmission occasion).

Optionally, the foregoing embodiments may further include the following step: The terminal selects (for example, through implementation) one HARQ process ID from the available HARQ processes of the configured grant PUSCH, and the terminal sends control information through the first N transmission occasions. The control information indicates the first HARQ process ID associated with a transmission occasion on which the control information is carried.

The first N transmission occasions in this embodiment may be the first N transmission occasions on which the configured grant PUSCH is actually transmitted within one period, whose positions depend on a transmission occasion from which the terminal starts transmission, and are different from the first N transmission occasions configured for the terminal within one period.

Optionally, that the terminal sends the control information through the first N transmission occasions includes: The terminal sends the control information on each of the first N transmission occasions. The control information is not sent on a transmission occasion after the N transmission occasions within the period. This helps reduce signaling overheads.

In this embodiment, N>1, which can avoid/alleviate a problem that when a network side device does not receive the 1^{st} or the first (N−1) transmission occasions on which transmission is actually performed, the network side device cannot determine a HARQ process ID corresponding to a subsequent transmission occasion, thereby improving communication effectiveness.

Optionally, in the foregoing embodiments, the second HARQ process ID may be determined based on the following formula:

$$Second HARQ process ID = ( H 1 + X ) modulo Q + P ;$$

where H1 is the HARQ process ID associated with the M transmission occasions before the M transmission occasions; modulo is a modulo operation; X is a predefined or higher-layer configured value, and X is a positive integer; Q is the number of available HARQ processes of the configured grant PUSCH; and P is a second offset, for example, may be equal to the foregoing harq-ProcID-Offset2.

In this embodiment, X=1, or X>1. When X>1, in this embodiment, overlapping between HARQ process IDs within adjacent periods can be avoided, so that HARQ process IDs within different periods are different from each other, thereby avoiding a problem that terminal communication is affected due to confused numbers of HARQ process IDs.

Descriptions are provided below by using an example. For example, when X=1, a plurality of HARQ process IDs within the 1^{st} period may be 1, 2, 3, and the like, and a plurality of HARQ process IDs within the 2^{nd} period may be 2, 3, 4, and the like. Therefore, there are overlapping numbers 2, 3, and the like, resulting in a problem that the numbers of the HARQ process IDs cannot be used, the PUSCH cannot be retransmitted (after the terminal transmits a TB, if the base station does not correctly decode the TB after receiving the TB, the base station needs a specific time to schedule retransmission of the TB; before the base station schedules retransmission of the TB, the terminal needs to temporarily store the TB in a buffer area, where a same HARQ process ID corresponds to a same buffer area; and if a new TB is to be buffered, the previous TB is cleared, and therefore retransmission cannot be performed), or the like. When X>1, for example, X=3, a plurality of HARQ process IDs within the 1^{st} period may be 1, 4, 7, and the like, a plurality of HARQ process IDs within the 2^{nd} period may be 2, 5, 8, and the like, and a plurality of HARQ process IDs within the 3^{rd} period may be 3, 6, and 9. This avoids overlapping between HARQ process IDs within the three adjacent periods.

$$Optionally , based on the method 200 , Third HARQ process ID = [ floor ( CURRENT\_symbol / periodicity ) + Occasion\_index ] modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion of each M transmission occasions; periodicity is a length of the period of the configured grant PUSCH; Occasion_index is a number of each transmission occasion within the period; nrofHARQ-Processes is the number of available HARQ processes of the configured grant PUSCH; and harq-ProcID-Offset2 is a first offset.

Optionally, based on the method 200, Third HARQ process ID=CURRENT_occasion modulo nrofHARQ-Processes+harq-ProcID-Offset2;

where modulo is a modulo operation; CURRENT_occasion is a number of each transmission occasion or the 1st transmission occasion of each M transmission occasions; nrofHARQ-Processes is the number of available HARQ processes of the configured grant PUSCH; and harq-ProcID-Offset2 is a first offset.

In this embodiment, positions and the number of transmission occasions are considered during HARQ process ID allocation, so that a case that different transmission occasions within adjacent periods correspond to a same HARQ process ID (a HARQ process conflict) can be avoided. For example, it is assumed that the number of available HARQ processes of the configured grant PUSCH is 12. HARQ process IDs determined within the 1^{st} period are 0, 1, 2, and 3; HARQ process IDs determined within the 2^{nd} period are 4, 5, 6, and 7; HARQ process IDs determined within the 3^{rd} period are 8, 9, 10, and 11; and HARQ process IDs determined with the 4^{th} period are 0, 1, 2, and 3. The HARQ processes is cycled based on the maximum number of processes that can be used for the configured grant PUSCH, thereby maximally avoiding a problem that HARQ process IDs conflict.

Optionally, CURRENT_occasion=floor[(SFN×numberOfSlotsPerFrame×numberOfSymbolsPerSlot+slot number in the frame×numberOfSymbolsPerSlot+symbol number in the slot)/periodicity]*numberOfOccasionsPerPeriod+Occasion_index;

where SFN is a system frame number (System Frame Number); numberOfSlotsPerFrame is the number of slots in each frame; numberOfSymbolsPerSlot is the number of symbols in each slot; slot number in the frame is a number of a slot in the frame; symbol number in the slot is a number of a symbol in the slot; periodicity is a length of the period of the configured grant PUSCH; numberOfOccasionsPerPeriod is the number of transmission occasions configured within one period of the configured grant PUSCH; and Occasion_index is a number of a transmission occasion.

In this embodiment, when repetition is configured for the configured grant PUSCH, numbers of a plurality of transmission occasions corresponding to a same TB are the same. numberOfOccasionsPerPeriod is the number of transmission occasions configured within one period of the configured grant PUSCH, and a plurality of transmission occasions corresponding to a same TB are denoted as one transmission occasion. Occasion index is a number of a transmission occasion, and numbers of a plurality of transmission occasions corresponding to a same TB are the same.

To describe the method for determining a HARQ process ID according to embodiments of this application in detail, several specific embodiments are used below for description.

An application scenario of embodiments of this application is shown in FIG. 3. One period of the configured grant PUSCH (CG PUSCH) includes four CG PUSCH transmission occasions: an OC 0, an OC 1, an OC 2, and an OC 3 in FIG. 3. Time domain lengths of the transmission occasions may be the same or different, and different transmission occasions may be continuous or discontinuous. This is not limited in this application. For each transmission occasion, the terminal may determine, by using the method provided in embodiments of this application, a HARQ process ID associated with the transmission occasion. If repetition (repetition) is configured for the CG PUSCH, a plurality of transmission occasions for repetition may be associated with a same/different transmission occasion indexes (or numbers).

### Embodiment 1

The terminal determines a HARQ process ID associated with the first N transmission occasions within a period of a configured grant PUSCH, where a second HARQ process ID associated with each M transmission occasions (M>1 when repetition is configured for the CG PUSCH) after the N transmission occasions within the transmission period is determined by sequentially increasing by X and obtaining the modulo of Q and then increasing by P.

For example, Second HARQ process ID=(H1+X) modulo Q+P;

where H1 is the HARQ process ID associated with the M transmission occasions before the M transmission occasions; modulo is a modulo operation; X is a predefined or higher-layer configured value, and X is a positive integer; Q is the number of available HARQ processes of the configured grant PUSCH; and P is a second offset, for example, may be equal to the foregoing harq-ProcID-Offset2.

In this embodiment, the terminal determines, based on implementation, the HARQ process ID associated with the first N transmission occasions, and notifies, by transmitting control information on these transmission occasions, the base station of a HARQ process ID associated with each transmission occasion.

Optionally, the control information is not transmitted on any transmission occasion after the first N transmission occasions within the period. This reduces signaling overheads.

### Embodiment 2

The terminal determines a HARQ process ID associated with the first N transmission occasions within a period of a configured grant PUSCH, where each M transmission occasions (M>1 when repetition is configured for the CG PUSCH) after the N transmission occasions within the transmission period are determined by sequentially increasing by X and obtaining the modulo of Q and then increasing by P.

For example, Second HARQ process ID=(H1+X) modulo Q+P;

where H1 is the HARQ process ID associated with the M transmission occasions before the M transmission occasions; modulo is a modulo operation; X is a predefined or higher-layer configured value, and X is a positive integer; Q is the number of available HARQ processes of the configured grant PUSCH; and P is a second offset, for example, may be equal to the foregoing harq-ProcID-Offset2.

In this embodiment, when neither HARQ-ProcID-Offset2 nor cg-RetransmissionTimer is configured for the configured grant PUSCH, the first HARQ process ID associated with the first N transmission occasions is determined based on the following formula:

$$First HARQ process ID = [ floor ( CURRENT\_symbol / periodicity ) ] modulo nrofHARQ - Processes ;$$

where floor is a round-down operation; modulo is a modulo operation; CURRENT_symbol is the 1^{st} symbol of each transmission occasion or the 1^{st} transmission occasion in the first N transmission occasions or the 1^{st} transmission occasion of each M transmission occasions; periodicity is a length of the period of the configured grant PUSCH; and nrofHARQ-Processes is the number of available HARQ processes of the configured grant PUSCH.

In this embodiment, when HARQ-ProcID-Offset2 is configured for the configured grant PUSCH, the first HARQ process ID associated with the first N transmission occasions is determined based on the following formula:

$$First HARQ process ID = [ floor ( CURRENT\_symbol / periodicity ) ] modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion in the first N transmission occasions or the 1^{st} transmission occasion of each M transmission occasions; periodicity is a length of the period of the configured grant PUSCH; nrofHARQ-Processes is the number of available HARQ processes of the configured grant PUSCH; and harq-ProcID-Offset2 is the first offset.

### Embodiment 3

The terminal determines, according to the following formula, a third HARQ process ID associated with each M transmission occasions within one period of the configured grant PUSCH:

$$Third HARQ process ID = [ floor ( CURRENT\_symbol / periodicity ) + Occasion\_index ] modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion of each M transmission occasions; periodicity is a length of the period of the configured grant PUSCH; Occasion index is a number of each transmission occasion within the period; nrofHARQ-Processes is the number of available HARQ processes of the configured grant PUSCH; and harq-ProcID-Offset2 is a first offset.

Optionally, the terminal may alternatively determine, according to the following formula, a third HARQ process ID associated with each M transmission occasions within one period of the configured grant PUSCH:

$$Third HARQ process ID = CURRENT\_occasion modulo nrofHARQ - Processes + harq - ProcID - Offset 2 ;$$

where modulo is a modulo operation; CURRENT_occasion is a number of each transmission occasion or the 1^{st} transmission occasion of each M transmission occasions;

nrofHARQ-Processes is the number of available HARQ processes of the configured grant PUSCH; and harq-ProcID-Offset2 is a first offset.

Optionally, CURRENT_occasion=floor[(SFN×numberOfSlotsPerFrame×numberOfSymbolsPerSlot+slot number in the frame×numberOfSymbolsPerSlot+symbol number in the slot)/periodicity]*numberOfOccasionsPerPeriod+Occasion_index;

where SFN is a system frame number (System Frame Number); numberOfSlotsPerFrame is the number of slots in each frame; numberOfSymbolsPerSlot is the number of symbols in each slot; slot number in the frame is a number of a slot in the frame; symbol number in the slot is a number of a symbol in the slot; periodicity is a length of the period of the configured grant PUSCH; numberOfOccasionsPerPeriod is the number of transmission occasions configured within one period of the configured grant PUSCH; and Occasion_index is a number of a transmission occasion.

In this embodiment, when repetition is configured for the configured grant PUSCH, numbers of a plurality of transmission occasions corresponding to a same TB are the same. numberOfOccasionsPerPeriod is the number of transmission occasions configured within one period of the configured grant PUSCH, and a plurality of transmission occasions corresponding to a same TB are denoted as one transmission occasion. Occasion_index is a number of a transmission occasion, and numbers of a plurality of transmission occasions corresponding to a same TB are the same.

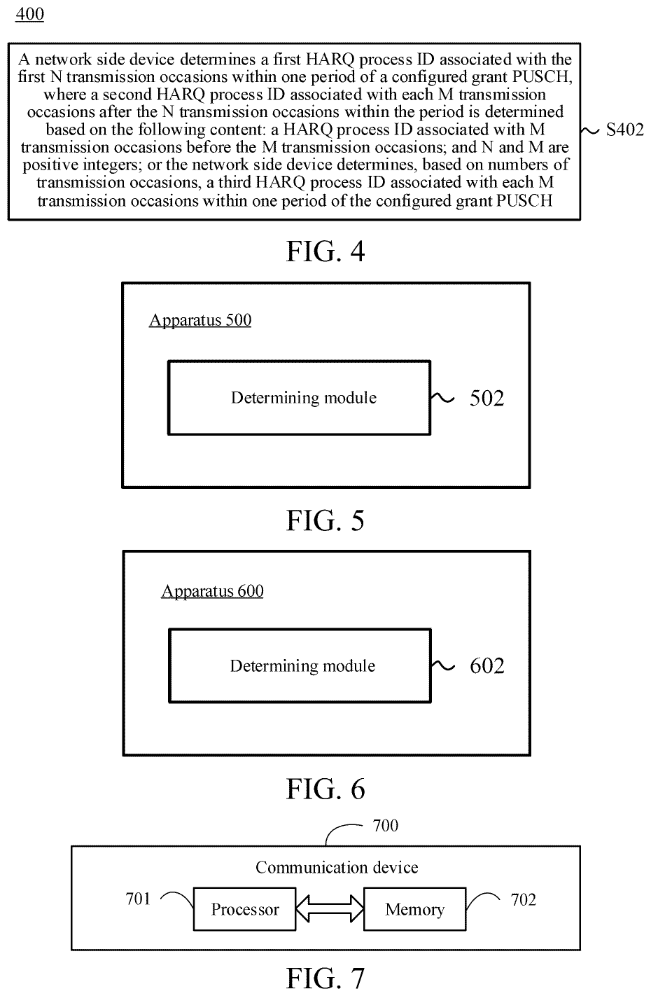

The foregoing describes, in detail with reference to FIG. 2, the method for determining a HARQ process ID according to embodiments of this application. The following describes, in detail with reference to FIG. 4, a method for determining a HARQ process ID according to another embodiment of this application. It may be understood that interaction between a network side device and a terminal that is described from a perspective of the network side device is the same as or corresponds to that described from a perspective of the terminal side in the method shown in FIG. 2. To avoid repetition, related descriptions are properly omitted.

FIG. 4 is a diagram of an implementation procedure of a method for determining a HARQ process ID according to an embodiment of this application, which may be applied to a network side device. As shown in FIG. 4, the method 400 includes the following step:

S402. The network side device determines a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions; and N and M are positive integers; or the network side device determines, based on numbers of transmission occasions, a third HARQ process ID associated with each M transmission occasions within one period of the configured grant PUSCH.

In this embodiment of this application, the network side device may determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions. Alternatively, the network side device may determine, based on numbers of transmission occasions, a third HARQ process ID associated with each M transmission occasions within one period of the configured grant PUSCH. In this embodiment of this application, HARQ process IDs associated with a plurality of transmission occasions within one period of the configured grant PUSCH can be determined, which helps improve effectiveness of a communication system.

Optionally, in an embodiment, at least two transmission occasions are configured within one period of the configured grant PUSCH; or transmission occasions for transmission of more than one TB are configured within one period of the configured grant PUSCH.

Optionally, in an embodiment, the method further includes: The network side device receives control information through the first N transmission occasions, where the control information indicates the first HARQ process ID associated with a transmission occasion on which the control information is carried. That the network side device determines the first HARQ process ID associated with the first N transmission occasions within one period of the configured grant PUSCH includes: The network side device determines, based on the control information, the first HARQ process ID associated with the first N transmission occasions within one period of the configured grant PUSCH.

Optionally, in an embodiment, that the network side device receives the control information through the first N transmission occasions includes: The network side device receives the control information on each of the first N transmission occasions. The control information is not received on a transmission occasion after the N transmission occasions within the period.

Optionally, in an embodiment, the second HARQ process ID is determined based on the following formula:

$$Second HARQ process ID = ( H 1 + X ) modulo Q + P ;$$

where H1 is the HARQ process ID associated with the M transmission occasions before the M transmission occasions; modulo is a modulo operation; X is a predefined or higher-layer configured value, and X is a positive integer; Q is the number of available HARQ processes of the configured grant PUSCH; and P is a second offset.

Optionally, in an embodiment, Third HARQ process ID=[floor(CURRENT_symbol/periodicity)+Occasion_index]modulo nrofHARQ-Processes+harq-ProcID-Offset2;

or

$$Third HARQ process ID = CURRENT\_occasion modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion of each M transmission occasions; periodicity is a length of the period of the configured grant PUSCH; Occasion_index is a number of each transmission occasion within the period; nrofHARQ-Processes is the number of available HARQ processes of the configured grant PUSCH; harq-ProcID-Offset2 is a first offset; and CURRENT_occasion is a number of each transmission occasion or the 1^{st} transmission occasion of each M transmission occasions.

Optionally, in an embodiment, when repetition is configured for the configured grant PUSCH, numbers of a plurality of transmission occasions corresponding to a same TB are the same.

The method for determining a HARQ process ID according to embodiments of this application may be performed by an apparatus for determining a HARQ process ID. In embodiments of this application, an example in which the apparatus for determining a HARQ process ID performs the method for determining a HARQ process ID is used to describe the apparatus for determining a HARQ process ID according to embodiments of this application.

FIG. 5 is a diagram of a structure of an apparatus for determining a HARQ process ID according to an embodiment of this application. The apparatus may correspond to a terminal in other embodiments. As shown in FIG. 5, the apparatus 500 includes the following module:

a determining module 502, configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions; and N and M are positive integers; or a determining module 502, configured to determine, based on numbers of transmission occasions, a third HARQ process ID associated with each M transmission occasions within one period of the configured grant PUSCH.

Optionally, the apparatus 500 further includes a communication module.

In this embodiment of this application, HARQ process IDs associated with a plurality of transmission occasions within one period of the configured grant PUSCH can be determined, which helps improve effectiveness of a communication system.

Optionally, in an embodiment, at least two transmission occasions are configured within one period of the configured grant PUSCH; or transmission occasions for transmission of more than one transport block TB are configured within one period of the configured grant PUSCH.

Optionally, in an embodiment, when neither a first offset nor a retransmission timer is configured for the configured grant PUSCH, the first HARQ process ID is determined based on the following formula:

$$First HARQ process ID = [ floor ( CURRENT\_symbol / periodicity ) ] modulo nrofHARQ - Processes ;$$

where floor is a round-down operation; modulo is a modulo operation; CURRENT_symbol is the 1^{st} symbol of each transmission occasion or the 1^{st} transmission occasion in the first N transmission occasions or the 1^{st} transmission occasion of each M transmission occasions; periodicity is a length of the period of the configured grant PUSCH; and nrofHARQ-Processes is the number of available HARQ processes of the configured grant PUSCH.

Optionally, in an embodiment, when a first offset is configured for the configured grant PUSCH, the first HARQ process ID is determined based on the following formula:

$$First HARQ process ID = [ floor ( CURRENT\_symbol / periodicity ) ] modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion in the first N transmission occasions or the 1^{st} transmission occasion of each M transmission occasions; periodicity is a length of the period of the configured grant PUSCH; nrofHARQ-Processes is the number of available HARQ processes of the configured grant PUSCH; and harq-ProcID-Offset2 is the first offset.

Optionally, in an embodiment, the apparatus further includes a sending module, configured to: select one HARQ process ID from the available HARQ processes of the configured grant PUSCH, and send control information through the first N transmission occasions, where the control information indicates the first HARQ process ID associated with a transmission occasion on which the control information is carried.

Optionally, in an embodiment, the sending module is configured to send the control information on each of the first N transmission occasions. The control information is not sent on a transmission occasion after the N transmission occasions within the period.

Optionally, in an embodiment, the second HARQ process ID is determined based on the following formula:

$$Second HARQ process ID = ( H 1 + X ) modulo Q + P ;$$

where H1 is the HARQ process ID associated with the M transmission occasions before the M transmission occasions; modulo is a modulo operation; X is a predefined or higher-layer configured value, and X is a positive integer; Q is the number of available HARQ processes of the configured grant PUSCH; and P is a second offset.

Optionally, in an embodiment,

$$Third HARQ process ID = [ floor ( CURRENT\_symbols / periodicity ) + Occasion\_index ] modulo nrofHARQ - Processes + harq - ProcID - Offset 2 ; or$$

$$Third HARQ process ID = CURRENT\_occasion modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion of each M transmission occasions; periodicity is a length of the period of the configured grant PUSCH; Occasion_index is a number of each transmission occasion within the period; nrofHARQ-Processes is the number of available HARQ processes of the configured grant PUSCH; harq-ProcID-Offset2 is a first offset; and CURRENT_occasion is a number of each transmission occasion or the 1^{st} transmission occasion of each M transmission occasions.

Optionally, in an embodiment, when repetition is configured for the configured grant PUSCH, numbers of a plurality of transmission occasions corresponding to a same TB are the same.

For the apparatus 500 according to this embodiment of this application, refer to corresponding procedures of the method 200 in embodiments of this application. In addition, the units/modules in the apparatus 500 and the foregoing other operations and/or functions are respectively used to implement corresponding procedures in the method 200, and can achieve the same or equivalent technical effects. For brevity, details are not described herein again.

The apparatus for determining a HARQ process ID in this embodiment of this application may be an electronic device, for example, an electronic device having an operating system; or may be a component in the electronic device, for example, an integrated circuit or a chip. The electronic device may be a terminal, or may be another device other than a terminal. For example, the terminal may include but is not limited to the foregoing listed types of the terminal 11, and the another device may be a server or a network attached storage (Network Attached Storage, NAS). This is not specifically limited in this embodiment of this application.

FIG. 6 is a diagram of a structure of an apparatus for determining a HARQ process ID according to an embodiment of this application. The apparatus may correspond to a network side device in other embodiments. As shown in FIG. 6, the apparatus 600 includes the following module:

a determining module 602, configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions; and N and M are positive integers; or a determining module 602, configured to determine, based on numbers of transmission occasions, a third HARQ process ID associated with each M transmission occasions within one period of the configured grant PUSCH.

Optionally, the apparatus 600 further includes a communication module.

In this embodiment of this application, HARQ process IDs associated with a plurality of transmission occasions within one period of the configured grant PUSCH can be determined, which helps improve effectiveness of a communication system.

Optionally, in an embodiment, at least two transmission occasions are configured within one period of the configured grant PUSCH; or transmission occasions for transmission of more than one TB are configured within one period of the configured grant PUSCH.

Optionally, in an embodiment, the apparatus further includes a receiving module, configured to receive control information through the first N transmission occasions, where the control information indicates the first HARQ process ID associated with a transmission occasion on which the control information is carried. The determining module 602 is configured to determine, based on the control information, the first HARQ process ID associated with the first N transmission occasions within one period of the configured grant PUSCH.

Optionally, in an embodiment, the receiving module is configured to receive the control information on each of the first N transmission occasions. The control information is not received on a transmission occasion after the N transmission occasions within the period.

Optionally, in an embodiment, the second HARQ process ID is determined based on the following formula:

$$Second HARQ process ID = ( H 1 + X ) modulo Q + P ,$$

where H1 is the HARQ process ID associated with the M transmission occasions before the M transmission occasions; modulo is a modulo operation; X is a predefined or higher-layer configured value, and X is a positive integer; Q is the number of available HARQ processes of the configured grant PUSCH; and P is a second offset.

Optionally, in an embodiment,

$$Third HARQ process ID = [ floor ( CURRENT\_symbols / periodicity ) + Occasion\_index ] modulo nrofHARQ - Processes + harq - ProcID - Offset 2 ; or$$

$$Third HARQ process ID = CURRENT\_occasion modulo nrofHARQ - Processes + harq - ProcID - Offset 2 ;$$

where floor is a round-down operation; modulo is a modulo operation; CURRENT_symbol is the 1^{st} symbol of each transmission occasion or the 1^{st} transmission occasion of each M transmission occasions; periodicity is a length of the period of the configured grant PUSCH; Occasion_index is a number of each transmission occasion within the period; nrofHARQ-Processes is the number of available HARQ processes of the configured grant PUSCH; harq-ProcID-Offset2 is a first offset; and CURRENT_occasion is a number of each transmission occasion or the 1^{st} transmission occasion of each M transmission occasions.

Optionally, in an embodiment, when repetition is configured for the configured grant PUSCH, numbers of a plurality of transmission occasions corresponding to a same TB are the same.

For the apparatus 600 according to this embodiment of this application, refer to corresponding procedures of the method 400 in embodiments of this application. In addition, the units/modules in the apparatus 600 and the foregoing other operations and/or functions are respectively used to implement corresponding procedures in the method 400, and can achieve the same or equivalent technical effects. For brevity, details are not described herein again.

The apparatus for determining a HARQ process ID according to embodiments of this application can implement the processes implemented in the method embodiments in FIG. 2 to FIG. 4, and achieve the same technical effects. To avoid repetition, details are not described herein again.

Optionally, as shown in FIG. 7, an embodiment of this application further provides a communication device 700, including a processor 701 and a memory 702. The memory 702 stores a program or instructions executable on the processor 701. For example, when the communication device 700 is a terminal, when the program or the instructions are executed by the processor 701, steps of the foregoing embodiments of the method for determining a HARQ process ID are performed, and the same technical effects can be achieved. When the communication device 700 is a network side device, when the program or the instructions are executed by the processor 701, steps of the foregoing embodiments of the method for determining a HARQ process ID are performed, and the same technical effects can be achieved. To avoid repetition, details are not described herein again.

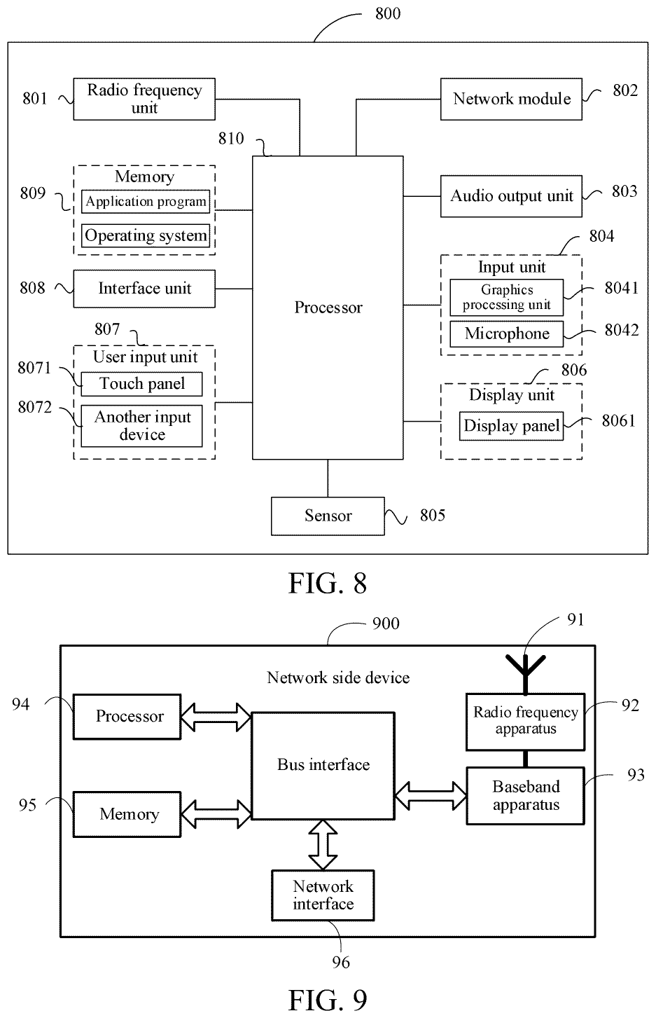

An embodiment of this application further provides a terminal, including a processor and a communication interface. The processor is configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers. Alternatively, the processor is configured to determine, based on numbers of transmission occasions, a third HARQ process ID associated with each M transmission occasions within one period of the configured grant PUSCH. The terminal embodiment corresponds to the foregoing terminal side method embodiment, and each implementation process and implementation of the method embodiment are applicable to the terminal embodiment, and the same technical effects can be achieved. Specifically, FIG. 8 is a diagram of a hardware structure of a terminal according to an embodiment of this application.

The terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 may further include a power supply (such as a battery) for supplying power to the components. The power supply may be logically connected to the processor 810 by using a power management system, to implement functions such as charging, discharging, and power consumption management by using the power management system. The terminal structure shown in FIG. 8 does not constitute a limitation on the terminal, and the terminal may include more or fewer components than shown those shown in the figure, or have some components combined, or have a different component arrangement. Details are not described herein.

It should be understood that in this embodiment of this application, the input unit 804 may include a graphics processing unit (Graphics Processing Unit, GPU) 8041 and a microphone 8042. The graphics processing unit 8041 processes image data of a static picture or a video that is obtained by an image capture apparatus (such as a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a switch button), a track ball, a mouse, or a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or instructions and various data. The memory 809 may mainly include a first storage area for storing a program or instructions and a second storage area for storing data. The first storage area may store an operating system, an application program or instructions required for at least one function (such as a sound playing function or an image playing function), and the like. In addition, the memory 809 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (static RAM, SRAM), a dynamic random access memory (dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), or a direct rambus random access memory (Direct Rambus RAM, DR RAM). The memory 809 in this embodiment of this application includes but is not limited to these and any other memory of a suitable type.

The processor 810 may include one or more processing units. Optionally, the processor 810 integrates an application processor and a modem processor. The application processor mainly processes operations related to an operating system, a user interface, an application program, and the like. The modem processor mainly processes wireless communication signals, and is, for example, a baseband processor. It may be understood that the modem processor may not be integrated into the processor 810.

The processor 810 may be configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers. Alternatively, the processor 810 may be configured to determine, based on numbers of transmission occasions, a third HARQ process ID associated with each M transmission occasions within one period of the configured grant PUSCH.

In this embodiment of this application, the terminal may determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions. Alternatively, the terminal may determine, based on numbers of transmission occasions, a third HARQ process ID associated with each M transmission occasions within one period of the configured grant PUSCH. In this embodiment of this application, HARQ process IDs associated with a plurality of transmission occasions within one period of the configured grant PUSCH can be determined, which helps improve effectiveness of a communication system.

The terminal 800 provided in this embodiment of this application can further implement the processes in the foregoing embodiments of the method for determining a HARQ process ID, and can achieve the same technical effects. To avoid repetition, details are not described herein again.

An embodiment of this application further provides a network side device, including a processor and a communication interface. The processor is configured to determine a first HARQ process ID associated with the first N transmission occasions within one period of a configured grant PUSCH, where a second HARQ process ID associated with each M transmission occasions after the N transmission occasions within the period is determined based on the following content: a HARQ process ID associated with M transmission occasions before the M transmission occasions, and N and M are positive integers. Alternatively, the processor is configured to determine, based on numbers of transmission occasions, a third HARQ process ID associated with each M transmission occasions within one period of the configured grant PUSCH. The network side device embodiment corresponds to the foregoing network side device method embodiment, and each implementation process and implementation of the method embodiment are applicable to the network side device embodiment, and the same technical effects can be achieved.

An embodiment of this application further provides a network side device. As shown in FIG. 9, the network side device 900 includes: an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information via the antenna 91, and sends the received information to the baseband apparatus 93 for processing. In a downlink direction, the baseband apparatus 93 processes information to be sent, and sends the information to the radio frequency apparatus 92, and the radio frequency apparatus 92 processes the received information and then sends the information via the antenna 91.

The method performed by the network side device in the foregoing embodiment may be implemented in the baseband apparatus 93. The baseband apparatus 93 includes a baseband processor.

The baseband apparatus 93 may include, for example, at least one baseband board, and a plurality of chips are disposed on the baseband board. As shown in FIG. 9, one of the chips is, for example, the baseband processor, which is connected to the memory 95 through a bus interface, to invoke a program in the memory 95 to perform a network side device operation described in the foregoing method embodiment.

The network side device may further include a network interface 96. The interface is, for example, a common public radio interface (common public radio interface, CPRI).

The network side device 900 in this embodiment of this application further includes: instructions or a program stored in the memory 95 and executable on the processor 94, and the processor 94 invokes the instructions or the program stored in the memory 95 to perform the method executed by each module shown in FIG. 6, and can achieve the same technical effects. To avoid repetition, details are not described herein again.

An embodiment of this application further provides a readable storage medium. The readable storage medium stores a program or instructions. When the program or the instructions are executed by a processor, the processes in the foregoing embodiments of the method for determining a HARQ process ID can be implemented, and the same technical effects can be achieved. To avoid repetition, details are not described herein again.

The processor is the processor in the terminal in the foregoing embodiment. The readable storage medium may be non-volatile or non-transient. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions, to implement the processes in the foregoing embodiments of the method for determining a HARQ process ID, and can achieve the same technical effects. To avoid repetition, details are not described herein again.

It should be understood that the chip in this embodiment of this application may also be referred to as a system-on-a-chip, a system chip, a chip system, a system on chip, or the like.

An embodiment of this application further provides a computer program/program product. The computer program/program product is stored in a storage medium. The computer program/program product is executed by at least one processor to implement the processes in the foregoing embodiments of the method for determining a HARQ process ID, and the same technical effects can be achieved. To avoid repetition, details are not described herein again.

An embodiment of this application further provides a system for determining a HARQ process ID, including: a terminal and a network side device. The terminal may be configured to perform steps of the foregoing method for determining a HARQ process ID, and the network side device may be configured to perform steps of the foregoing method for determining a HARQ process ID.

It should be noted that the terms “include”, “comprise”, or any other variation thereof in this specification is intended to cover a non-exclusive inclusion. Therefore, a process, method, object, or apparatus that includes a series of elements not only includes such elements, but also includes other elements not specified expressly, or may include inherent elements of the process, method, object, or apparatus. Unless otherwise specified, an element defined by “include a/an . . . ” does not exclude other same elements existing in the process, method, object, or apparatus that includes the element. Moreover, it should be noted that the scope of the method and apparatus in embodiments of this application is not limited to executing the functions in the order shown or discussed, but may include executing the functions in a substantially concurrent manner or in a reverse order depending on the related functions. For example, the method described may be performed in an order different from that described, and various steps may be further added, omitted, or combined. In addition, features described with reference to some examples may be combined in other examples.

Through the descriptions of the foregoing implementations, a person skilled in the art may clearly understand that the methods according to the foregoing embodiments may be implemented by a computer software product plus a necessary general hardware platform, and certainly, may alternatively be implemented by hardware. The computer software product is stored in a storage medium (such as a ROM, a RAM, a magnetic disk, or an optical disc), and includes several instructions for instructing a terminal or a network side device to perform the method described in embodiments of this application.

Embodiments of this application have been described above with reference to the accompanying drawings, but this application is not limited to the specific embodiments, and the specific embodiments are merely examples rather than limitative. A person of ordinary skill in the art may make various forms of implementations under the teaching of this application without departing from the essence of this application and the protection scope of the claims, and such implementations shall all fall within the protection scope of this application.

What is claimed is:

1. A method for determining a hybrid automatic repeat request HARQ process identifier ID, comprising:
determining, by a terminal based on numbers of transmission occasions, a third HARQ process ID associated with each M transmission occasions within one period of a configured grant physical uplink shared channel, PUSCH, M being a positive integer.

2. The method according to claim 1, wherein
at least two transmission occasions are configured within one period of the configured grant PUSCH.

3. The method according to claim 1, wherein
M=1.

4. The method according to claim 1, wherein
$$Third HARQ process ID = [ floor [ ( SFN \times numberOfSlotsPerFrame \times numberOfSymbolsPerSlots + slot number in the frame \times numberOfSymbolsPerSlot + symbol number in the slot ) / periodicity ] * numberOfOccasionsPerPeriod + Occasion\_index ] modulo nrofHARQ - Processes + harq - ProcID - Offset 2 ;$$
wherein floor is a round-down operation;
modulo is a modulo operation;
periodicity is a length of the period of the configured grant PUSCH;
Occasion index is a number of each transmission occasion within the period;
nrofHARQ-Processes is the number of available HARQ processes of the configured grant PUSCH;
harq-ProcID-Offset2 is a first offset;
SFN is a system frame number;
numberOfSlotsPerFrame is the number of slots in each frame;
numberOfSymbolsPerSlot is the number of symbols in each slot;
slot number in the frame is a number of a slot in the frame;
symbol number in the slot is a number of a symbol in the slot; and
numberOfOccasionsPerPeriod is the number of transmission occasions configured within one period of the configured grant PUSCH.

5. The method according to claim 4, wherein
when repetition is configured for the configured grant PUSCH, numbers of a plurality of transmission occasions corresponding to a same TB are the same.

6. The method according to claim 4, wherein the first offset is configured in the configured grant PUSCH.

7. The method according to claim 1, wherein the first offset is not configured in the configured grant PUSCH,
$$Third HARQ process ID = [ floor [ ( SFN \times numberOfSlotsPerFrame \times numberOfSymbolsPerSlots + slot number in the frame \times numberOfSymbolsPerSlot + symbol number in the slot ) / periodicity ] * numberOfOccasionsPerPeriod + Occasion\_index ] modulo nrofHARQ - Processes ,$$
wherein floor is a round-down operation;
modulo is a modulo operation;
periodicity is a length of the period of the configured grant PUSCH;
Occasion_index is a number of each transmission occasion within the period;
nrofHARQ-Processes is the number of available HARQ processes of the configured grant PUSCH;
SFN is a system frame number;
numberOfSlotsPerFrame is the number of slots in each frame;
numberOfSymbolsPerSlot is the number of symbols in each slot;
slot number in the frame is a number of a slot in the frame;
symbol number in the slot is a number of a symbol in the slot; and
numberOfOccasionsPerPeriod is the number of transmission occasions configured within one period of the configured grant PUSCH.

8. A method for determining a HARQ process ID, comprising:
determining, by a network side device based on numbers of transmission occasions, a third HARQ process ID associated with each M transmission occasions within one period of a configured grant PUSCH, M being a positive integer.

9. The method according to claim 8, wherein
at least two transmission occasions are configured within one period of the configured grant PUSCH.

10. The method according to claim 8, wherein
$$Third HARQ process ID = [ floor [ ( SFN \times numberOfSlotsPerFrame \times numberOfSymbolsPerSlots + slot number in the frame \times numberOfSymbolsPerSlot + symbol number in the slot ) / periodicity ] * numberOfOccasionsPerPeriod + Occasion\_index ] modulo nrofHARQ - Processes + harq - ProcID - Offset 2 ;$$
wherein floor is a round-down operation;
modulo is a modulo operation;
periodicity is a length of the period of the configured grant PUSCH;
Occasion index is a number of each transmission occasion within the period;
nrofHARQ-Processes is the number of available HARQ processes of the configured grant PUSCH;
harq-ProcID-Offset2 is a first offset;
SFN is a system frame number;
numberOfSlotsPerFrame is the number of slots in each frame;
numberOfSymbolsPerSlot is the number of symbols in each slot;
slot number in the frame is a number of a slot in the frame;
symbol number in the slot is a number of a symbol in the slot; and
numberOfOccasionsPerPeriod is the number of transmission occasions configured within one period of the configured grant PUSCH.

11. The method according to claim 10, wherein
when repetition is configured for the configured grant PUSCH, numbers of a plurality of transmission occasions corresponding to a same TB are the same.

12. The method according to claim 10, wherein the first offset is configured in the configured grant PUSCH.

13. The method according to claim 8, wherein the first offset is not configured in the configured grant PUSCH,
$$Third HARQ process ID = [ floor [ ( SFN \times numberOfSlotsPerFrame \times numberOfSymbolsPerSlots + slot number in the frame \times numberOfSymbolsPerSlot + symbol number in the slot ) / periodicity ] * numberOfOccasionsPerPeriod + Occasion\_index ] modulo nrofHARQ - Processes ,$$
wherein floor is a round-down operation;
modulo is a modulo operation;
periodicity is a length of the period of the configured grant PUSCH;
Occasion index is a number of each transmission occasion within the period;
nrofHARQ-Processes is the number of available HARQ processes of the configured grant PUSCH;
SFN is a system frame number;
numberOfSlotsPerFrame is the number of slots in each frame;
numberOfSymbolsPerSlot is the number of symbols in each slot;
slot number in the frame is a number of a slot in the frame;
symbol number in the slot is a number of a symbol in the slot; and
numberOfOccasionsPerPeriod is the number of transmission occasions configured within one period of the configured grant PUSCH.

14. A terminal, comprising a processor and a memory, wherein the memory stores a program or instructions executable on the processor, and when the program or instructions are executed by the processor, steps of a method for determining a hybrid automatic repeat request HARQ process identifier ID are implemented, the method comprising:
determining, by the terminal based on numbers of transmission occasions, a third HARQ process ID associated with each M transmission occasions within one period of a configured grant PUSCH, M being a positive integer.

15. The terminal according to claim 14, wherein
at least two transmission occasions are configured within one period of the configured grant PUSCH.

16. The terminal according to claim 14, wherein
M=1.

17. The terminal according to claim 14, wherein
$$Third HARQ process ID = [ floor [ ( SFN \times numberOfSlotsPerFrame \times numberOfSymbolsPerSlots + slot number in the frame \times numberOfSymbolsPerSlot + symbol number in the slot ) / periodicity ] * numberOfOccasionsPerPeriod + Occasion\_index ] modulo nrofHARQ - Processes + harq - ProcID - Offset 2 ;$$
wherein floor is a round-down operation;
modulo is a modulo operation;
periodicity is a length of the period of the configured grant PUSCH;
Occasion_index is a number of each transmission occasion within the period;
nrofHARQ-Processes is the number of available HARQ processes of the configured grant PUSCH;
harq-ProcID-Offset2 is a first offset;
SFN is a system frame number;
numberOfSlotsPerFrame is the number of slots in each frame;
numberOfSymbolsPerSlot is the number of symbols in each slot;
slot number in the frame is a number of a slot in the frame;
symbol number in the slot is a number of a symbol in the slot; and
numberOfOccasionsPerPeriod is the number of transmission occasions configured within one period of the configured grant PUSCH.

18. The terminal according to claim 17, wherein the first offset is configured in the configured grant PUSCH.

19. The terminal according to claim 14, wherein the first offset is not configured in the configured grant PUSCH,
$$Third HARQ process ID = [ floor [ ( SFN \times numberOfSlotsPerFrame \times numberOfSymbolsPerSlots + slot number in the frame \times numberOfSymbolsPerSlot + symbol number in the slot ) / periodicity ] * numberOfOccasionsPerPeriod + Occasion\_index ] modulo nrofHARQ - Processes ,$$
wherein floor is a round-down operation;
modulo is a modulo operation;
periodicity is a length of the period of the configured grant PUSCH;
Occasion index is a number of each transmission occasion within the period;
nrofHARQ-Processes is the number of available HARQ processes of the configured grant PUSCH;
SFN is a system frame number;
numberOfSlotsPerFrame is the number of slots in each frame;
numberOfSymbolsPerSlot is the number of symbols in each slot;
slot number in the frame is a number of a slot in the frame;
symbol number in the slot is a number of a symbol in the slot; and
numberOfOccasionsPerPeriod is the number of transmission occasions configured within one period of the configured grant PUSCH.

20. A network side device, comprising a processor and a memory, wherein the memory stores a program or instructions executable on the processor, and when the program or instructions are executed by the processor, steps of the method according to claim 8 are implemented.
